(19) United States
(12) Patent Application Publication
(10) Pub. No.: US 2020/0042484 A1
(43) Pub. Date: Feb. 6, 2020

(54) INTEGRATED CIRCUIT WITH HOT PLUG CONTROL

(71) Applicant: HEWLETT PACKARD ENTERPRISE DEVELOPMENT LP, Houston, TX (US)

(72) Inventors: Walter Nixon, Milpitas, CA (US); William Price, Milpitas, CA (US); Chengjun Zhu, Milpitas, CA (US)

(21) Appl. No.: 16/050,144

(22) Filed: Jul. 31, 2018

(51) Int. Cl. G06F 13/40; G06F 13/42; G06F 13/16

(52) U.S. Cl. CPC G06F 13/4081; G06F 13/4027; G06F 2213/0026; G06F 13/1668; G06F 2213/0016; G06F 13/4282

(57) ABSTRACT

A system comprising: a first host and a second host; and an integrated circuit comprising: a first bus and a second bus physically separate and isolated from the first bus; a first host interface to connect the first host to the first bus and a second host interface to connect the second host to the second bus; and a hot plug control channel including first and second hot plug control registers, wherein each of the hot plug control registers is connectable to a hot pluggable device; wherein the hot plug control channel is to connect the first bus to the first and second hot plug control register to thereby connect the first host to the first and second hot plug control register, and is to connect the second bus to the first and second hot plug control register to thereby connect the second host to the first and second hot plug control register.

### BACKGROUND

Peripheral Component interconnect express (PCIe) hot plug controllers are generally discrete components. The PCIe hot plug controllers take up space on a systems motherboard, mid-plane, or back-plane. Additionally, extra components are utilized if reliability and availability are to taken into account, at least doubling printed circuit board (PCB) real estate consumed. With the support of multiple PCIe cards, more PCIe hot plug controllers may be utilized, thus increasing PCB real estate consumed, especially in the case of redundant PCIe hot plug controllers.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a block diagram of a system including a first host, a second host, a hot pluggable device, and an integrated circuit;

FIG. 2 is a block diagram of a system including a plurality of hosts, an integrated circuit, and a plurality of devices;

FIG. 3 is a block diagram of a system including two hosts, a plurality of devices, and an integrated circuit;

FIG. 4 is a flow chart of a method to, by an integrated circuit, receive a PCIe device, generate an interrupt, and send the interrupt to a host; and

FIG. 5 is a block diagram of a computing device to detect a PCIe device, generate an interrupt, and send the interrupt to a host.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Peripheral Component interconnect express (PCIe) hot plug controllers are generally discrete components. The PCIe hot plug controllers take up space on a systems motherboard, mid-plane, or back-plane. Additionally, extra components are utilized if reliability and availability are taken into account, at least doubling printed circuit board (PCB) real estate consumed. With the support of multiple PCIe cards, more PCIe hot plug controllers may be utilized, thus increasing PCB real estate consumed, especially in the case of redundant PCIe hot plug controllers.

Examples described herein include an integrated circuit. The integrated circuit may be a hot plug controller for a plurality of devices. The integrated circuit may include a plurality of hot plug control channels. Each hot plug control channel may include one or more hot plug control register sets. Each hot plug control channel (via the hot plug control register sets) may connect to or receive a device. The device may be a PCIe device. Further, the device may be a non-volatile memory express (NVMe) drive. In another example, the device may be some other drive or PCIe device. The integrated circuit may support as many devices as are included in a system and could scale to any size (the size of the integrated circuit limited by the physical size of the system, devices included in the system, hosts included in or supported by the system, and/or the number of components (for redundancy or other purposes) included in the integrated circuit). The integrated circuit may also support one or more hosts. The integrated circuit may include a plurality of redundant buses. The integrated circuit may scale in terms of physical size. In other words, in the case where a large amount of devices and/or hosts are supported, the integrated circuit may be physically larger in size (to support the multiple devices and/or hosts) than compared to a case where a lesser amount of devices and/or hosts are supported. This solution may significantly reduce cost and increase reliability and availability of a hot plug controller (e.g., a PCIe or NVMe hot plug controller).

Accordingly, various examples may include a system including an integrated circuit. The system may include a plurality of hosts (for example, a first host and a second host), the integrated circuit, and a plurality of devices (for example, hot pluggable devices). The integrated circuit may be connected to a slot or slots. The slot may accept the devices. The integrated circuit may control the hot pluggability of the devices. In other words, the integrated circuit may facilitate or allow a user to add a device to the system, while the system is powered on. The integrated circuit may also connect to the plurality of hosts. The integrated circuit may connect to a plurality of hosts via an interface or interfaces (as in, a host interface or host interfaces). The interface or interfaces may connect to the plurality of hosts via an inter integrated circuit (I²C) bus, a serial bus (for example, the Serial Peripheral Interface (SPI) bus), a parallel bus (for example, the Low Pin Count (LPC) bus), or some other similar bus capable of transferring data between devices and/or components.

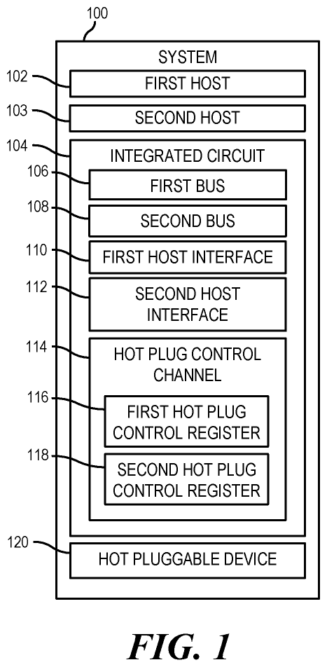

FIG. 1 is a block diagram of a system 100 including a first host 102, a second host 103, a hot pluggable device 120, and an integrated circuit 104. The system 100 may include one host (for example, the first host 102) or a plurality of hosts (for example, the first host 102 and the second host 103). The system 100 may include slots or connectors for a hot pluggable device 120 or plurality of hot pluggable devices. The slots or connectors may connect to the integrated circuit 104. Each slot or connector may connect to a hot plug control channel 114 included in the integrated circuit 104. The integrated circuit may include a first bus 106 and a second bus 108. The first bus 106 may be physically separate and isolated from the second bus 108. The integrated circuit 104 may include a first host interface 110 to connect the first host 102 to the first bus 106 and a second host interface 112 to connect the second host 103 to the second bus 108. The integrated circuit 104 may include a hot plug control channel 114 or a plurality of hot plug control channels. The hot plug control channel 114 may include a first hot plug control register 116 and a second hot plug control register 118. The hot pluggable device 120 may include two ports to connect to the first hot plug control register 116 and the second hot plug control register 118 of the hot plug control channel 114. In other words, the first host 102 may connect to the hot pluggable device 120 via the first and/or second hot plug control register 116, 118 (included in the hot plug control channel 114) through the first bus 106 and through the first host interface 110. The second host 103 may connect to the hot pluggable device 120 via the first and/or second hot plug control register 116, 118 (included in the hot plug control channel 114) through the second bus 108 and through the second host interface 112

As used herein, a “computing device” may be a storage array, storage device, storage enclosure, server, desktop or laptop computer, computer cluster, node, partition, virtual machine, or any other device or equipment including a controller, a processing resource, or the like. In examples described herein, a “processing resource” may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Any machine-readable storage medium described herein may be non-transitory.

As used herein, “hot plug” may refer to the act of adding a component or components to a system while the system is powered on and/or running. Further, hot plug may include the continued operation of the system without significant interruption when the component or components are added. In other words, a device may be added to a system while the system is operating and the user or the system itself may perform an administrative task, so that the added device can be utilized. Hot plug may also be referred to with terms such as, hot pluggable, hot plugging, or hot pluggability. For example, a device may be noted to be “hot pluggable”.

As used herein, “hot swap” may refer to the act of replacing, removing, or adding a component or components while the system is powered on and/or running. Further, hot swap may include the continued operation of the system without interruption. In other words, in response to a hot swap operation (for example, replacing one device with a new device), a system may operate as normal without interruption. Hot swap may also be referred to with terms such as, hot swappable, hot swapping, or hot swappability. In other words, a device may be noted to be “hot swappable”.

As used herein, a “host” may include a subsystem or a component of an overall system. A host may be a node, cartridge, blade, controller, storage controller, an application specific integrated circuit (ASIC), a system on a chip (SOC), a microcontroller, or combination of components. A host may, physically or virtually, include a processing resource and memory. A host may include an operating system or environment. A host may connect to multiple devices, for example, PCIe devices and/or storage devices. A system or computing device may include one or more hosts. In an example, a host may communicate with other hosts. Hosts may determine which host may initialize devices, write to devices, power on or off devices, and/or perform various other tasks.

As described above, FIG. 1 is a block diagram of a system 100 including a first host 102, a second host 103, a hot pluggable device 120, and an integrated circuit 104. In an example, the first host 102 and second host 103 (as well as any other hosts included in system 100) may connect to the integrated circuit 104 via a first host interface 110 and a second host interface 112, respectively, on the integrated circuit 104. In another example, the first host 102 and second host 103 (as well as any other hosts included in system 100) may be connected to the integrated circuit 104 via a point-to-point connection. In a further example, the first host 102 and second host 103 (as well as any other hosts included in system 100) may connect to an individual interface (as in, the first host interface 110 and second host interface 112, respectively) on the integrated circuit 104. In a further example, the first host 102 and second host 103 (as well as any other hosts included in system 100) may connect to the first host interface 110 and second host interface 112, respectively, of the integrated circuit 104 via a bus. In a further example, the bus may be an I²C bus, a serial bus (for example, the SPI interface), a parallel bus (for example, the LPC bus), or some other similar bus or interface capable of transferring data between devices and/or components. In another example, the first bus 106 and the second bus 108 (as well as any other buses included in the integrated circuit 104) may be associated with an interrupt. The interrupt may allow the first host 102 and the second host 103 (as well as any other host included in the system) to respond to changes in the hot plug control channel 114. For example, in response to a user adding the hot pluggable device 120 to the system 100, the integrated circuit 104 may generate an interrupt to send to the first host 102 and the second host 103 over the first bus 106 and the second bus 108, respectively, the interrupt to allow the first host 102 or the second host 103 to respond to the addition of the hot pluggable device 120 (as in, the first host 102 or the second host 103 may perform the tasks associated with the addition of the hot pluggable device 120). Further, the first host 102 may communicate with the second host 103 and determine which host 102, 103 may perform tasks associated with the addition of the hot pluggable device 120. In another example, the first host 102 and the second host 103 may connect to the integrated circuit 104 via redundant interfaces. In other words, a host (e.g., the first host 102) may connect to the integrated circuit 104 via two or more host interfaces, for reliability and availability purposes (as in, if one connection fails, then another connection is still there to prevent total failure). The connections between the first host 102 and the second host 103 and the integrated circuit 104 may facilitate data transfer regarding data pertinent to the hot plugging or hot swapping of the hot pluggable device 120 (as well as other hot pluggable or hot swappable devices in system 100).

As noted, system 100 may include an integrated circuit 104. In an example, the integrated circuit 104 may be a single integrated device, a microchip, an ASIC, a SOC, a PIC, a microcontroller, a complex programmable logic device (CPLD), or some other integrated circuit. In another example, the integrated circuit 104 may be an FPGA. In such examples, the integrated circuit may be defined based on a hardware description language (HDL). Further, the integrated circuit may be modified (via the HDL) per implementation. For example, a system 100 may include a number of hosts and a number of devices, while a different system may include a different number of hosts and a different number of devices. In such examples, the integrated circuit 104 may include a different number of internal components, defined by the HDL. Further, the modification of the integrated circuit 104, in the instances given above, may be performed quickly and at low cost. In another example, the integrated circuit 104 may include pins. Further, the integrated circuit 104 may be mounted to a PCB. In a further example, the pins may be physically connected to the first host 102, the second host 103, a plurality of hosts, and devices (for example, hot pluggable devices) or slots capable of accepting or receiving devices (e.g., hot pluggable devices). In an example, the integrated circuit 104 may vary in physical size. In an example, the physical size of the integrated circuit 104 may vary based on the amount of hosts to be supported and/or the amount of the devices (e.g., hot pluggable devices to be supported). For example, a system 100 may include four hosts. In such an example, the system may also include slots for eight hot pluggable devices. Further, the integrated circuit 104 may be designed in such a way to support the aforementioned amount of hosts and hot pluggable devices. In other words, the integrated circuit 104 may include enough physical pins to connect to four hosts and eight hot pluggable devices.

In another example, the integrated circuit 104 may include a hot plug control channel 114. In another example, the integrated circuit 104 may include a plurality of hot plug control channels. In an example, each hot plug control channel of the plurality of hot plug control channels may include hot plug control register sets (for example, hot plug control channel 114 may include a first hot plug control register 116 and a second hot plug control register 118). In a further example, each hot plug control register set (e.g., the first hot plug control register 116 and the second hot plug control register 118) may physically connect to ports (for example, redundant ports) of a device (e.g., ports on the hot pluggable device 120). In another example, the hot plug control register sets (e.g., the first hot plug control register 116 and the second hot plug control register 118) may be accessed via an I²C device ID. In other words, each hot plug control register set may (e.g., the first hot plug control register 116 and the second hot plug control register 118) include a different I²C device ID. In another example, each hot plug control register set (e.g., the first hot plug control register 116 and the second hot plug control register 118) may be separated into its own private 256 byte address space. In other words, each hot plug control channel of the plurality of hot plug control channels may include a private memory map (in other words, each hot plug control register set includes its own private memory region in the integrated circuit 104). In the examples described above, the hot plug control channels provide redundancy (via the hot plug control register sets). For example, if one hot plug control register set fails in a particular hot plug control channel, the other hot plug control register set may still operate as normal, thus continuing to provide operational support to the system 100.

In another example, the integrated circuit 104 may offer containment or, in other words, protect against faults or failures from the first host 102 and/or the second host 103. For example, a user may update the firmware and software associated with the first host 102 and/or the second host 103. Further, the firmware and software may be faulty or, in other words, introduce a fault into system 100. In such examples, such a fault may cause the first host 102 and/or the second host 103 to attempt to write bad data or instructions to the hot pluggable device 120. The instructions may include an instruction to power down the hot pluggable device 120 (or all hot pluggable devices in system 100). In such examples, the hot plug control channel 114 (or plurality of hot plug control channels) may include instructions (for example, each hot plug control register set (e.g., the first hot plug control register 116 and the second hot plug control register 118) may include, in the hot plug control register set's private memory region, the instructions) to detect such faults or failures from the first host 102 and/or the second host 103 and, in response to the detection of such faults or failures from the first host 102 and/or second host 103, offer containment or, in other words, prevent the first host 102 and/or the second host 103 from writing/sending the bad data or instructions to the hot pluggable device 120.

In another example, the integrated circuit 104 may include a first bus 106 and a second bus 108. In another example, the integrated circuit may include a plurality of buses. In an example, each bus may connect, through a host interface, to a host. In other words, the integrated circuit 104 may include a dedicated bus (from the plurality of buses included in the integrated circuit 104) per host of the plurality of hosts. In such examples, each bus may be physically separate and isolated from the other buses. In another example, each bus may connect, through an interface, to a plurality of hosts. In another example, each bus may connect the plurality of devices (e.g., hot pluggable devices), through a plurality of hot plug control channels, to each of a plurality of hosts. In a further example, the integrated circuit 104 may include any number of buses based on the amount of hosts and/or the amount of devices supported by the system 100. As noted above, each bus may be physically separate and isolated from the rest of the plurality of buses. In other words, each bus may be distinct, dedicated, and/or isolate, thus activity on one bus may not affect activity on another bus. For example, activity on the first bus 106 may not affect activity on the second bus 108 and activity on the second bus 108 may not affect activity on the first bus 106.

In another example, the system 100 may include a plurality of devices or slots for a plurality of devices (for example a user may add devices at a later time). In an example, the devices may be a hot pluggable device 120. In another example, the hot pluggable device 120 may be a hot pluggable PCIe card. In a further example, the hot pluggable PCIe device may be an NVMe storage device. In another example, the devices may be hot swappable devices. In another example, the integrated circuit 104 may support any number of devices. In a further example, the integrated circuit 104 may be limited by the size of the system 100 overall and/or the amount of devices the system 100 may support.

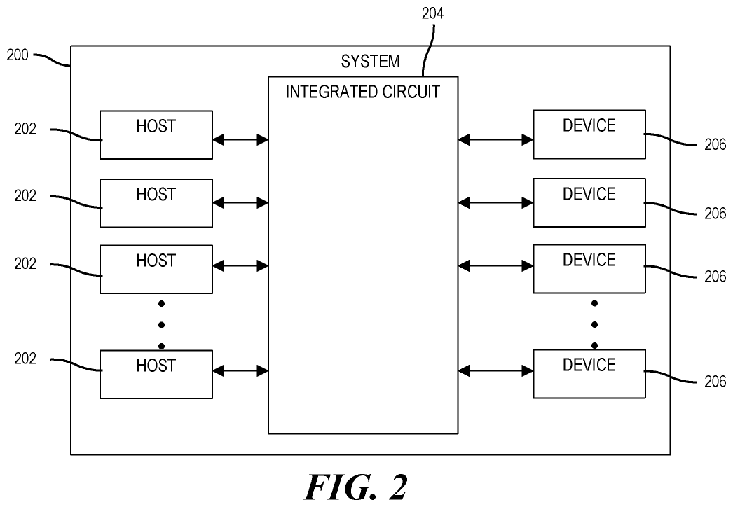

FIG. 2 is a block diagram of a system 200 including a plurality of hosts 202, an integrated circuit 204, and a plurality of devices 206. In such examples, the system 200 may include a number of hosts 202. As noted, the system 200 may support a number of hosts 202 which may be limited by the size of the system 200 itself. In another example, the system 200 may include an integrated circuit 204. In an example, the integrated circuit 204 may be disposed on a PCB or motherboard of the system 200. The physical size of the integrated circuit 204 may be based on the number of hosts 202 in the system 200, the number of devices 206 in the system 200, the number of hot plug control register sets included in each hot plug control channel in the integrated circuit 204, and/or the number of buses included in the integrated circuit 204. Note that FIG. 2 is not to scale, as the hosts 202 may include various components and the hosts 202, integrated circuit 204, and devices 206 may vary in size.

As noted above, system 200 may include a plurality of devices 206. In an example, system 200 may include slots or interfaces which may accept devices 206. For example, a user may plug or add a device into a slot on system 200. In an example, the slot or interface may be a PCIe slot or interface. In such examples, the devices 206 may be devices with a PCIe interface. In a further example, pins from each PCIe device may connect to the integrated circuit 204, when the PCIe device is added to the system 200. Further, the peripheral component interconnect (PCI) hot plug specification may define the pins to connect to the integrated circuit 204, when a PCIe device is added to the system 200.

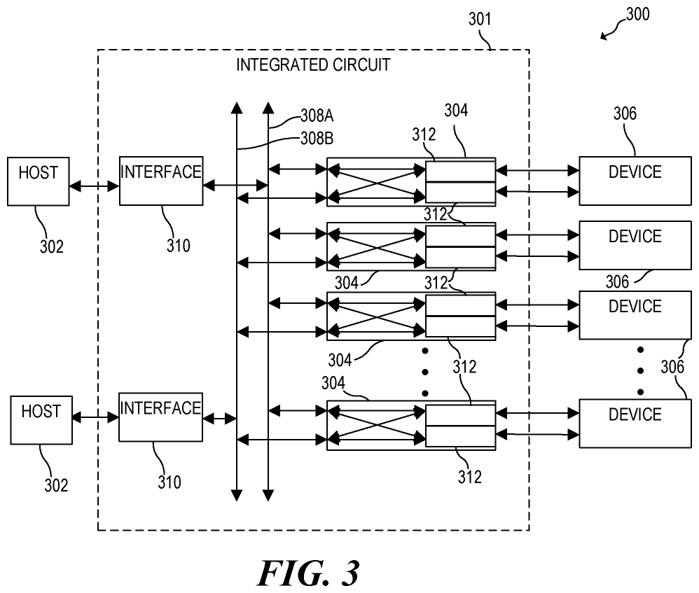

FIG. 3 is a block diagram of a system 300 including two hosts 302, a plurality of devices 306, and an integrated circuit 301 including a redundant bus 308A and 308B, two interfaces 310, and a plurality of hot plug control channels 304 including hot plug control register sets 312. System 300 may include two hosts 302. As described above, a system may include more hosts. The hosts 302 may connect to the integrated circuit 301 via an interface 310. The connection between the hosts 302 and the interface 310 may be an I²C bus. The interface 310, which may be part of the integrated circuit 301, may connect the hosts 302 to a bus 308A, 308B to connect the hosts 302 to a hot plug control channel 304. In other words, bus 308A and 308B may connect the interface 310 to the hot plug control channel 304.

In another example, the interface 310 may generate an interrupt. In response to an addition of a device 306, the interface 310 may generate an interrupt. In response to the generation of the interrupt, the interface 310 may send the interrupt to the host 302. In an example, the interface 310 may send the interrupt to all hosts included in the system or computing device 500. The interrupt may include information to notify the host 302 or hosts of the addition of a new device 306. The interrupt may include information on the actions the host or hosts may take after the addition of the new device 306.

In another example, the hot plug control channels 304 may include two hot plug control register sets 312. Further, each hot plug control register set 312 set may control redundant ports on the plurality of devices 306. In another example, the hot plug control channels 304 may include one hot plug control register set 312. In another example, the hot plug control channels 304 may include more than two hot plug control register sets 312.

In another example, system 300 may include more or less hosts 302 than shown. Additionally, system 300 may include more devices 306. Further, the system 300 may support a plurality of hosts 302 and a plurality of devices 306, limited by the physical size of the system 300 itself. In other words, the integrated circuit 301 may scale to support as many devices 306 and hosts 302 as the system 300 supports.

In another example, the buses 308 (through the interface 310) may connect the hosts 302 to one of or both of the hot plug control register sets 312 included in a hot plug control channel. All hosts may have access to devices 306 through the connections described above. In a further example, a particular host may write to a device 306 through a particular hot plug control register set and notify all other hosts of the write. In other words, hosts 302 may communicate to each other about writes (as well as other functions, such as power on, power off, initialize, read, and other tasks) to devices 306 that occur through a hot plug control register set. In another example, the integrated circuit 301 may generate an interrupt upon addition or removal of a device 306. In such examples, the interfaces 310, hot plug control channels 304, hot plug control register sets 312, some other component in the integrated circuit to generate interrupts, or some combination thereof may generate the interrupt and may send the interrupt in response to the generation of an interrupt. In such example, the interrupt may be sent to all hosts. As noted above, the hosts may communicate with all other hosts. In the event that an interrupt is sent, a particular host, according to a pre-determination or pre-agreement amongst all hosts, may perform the tasks associated with the interrupt (such as, initialization, power on, power off, write, and or read). In another example, the interrupt may be sent to a particular host.

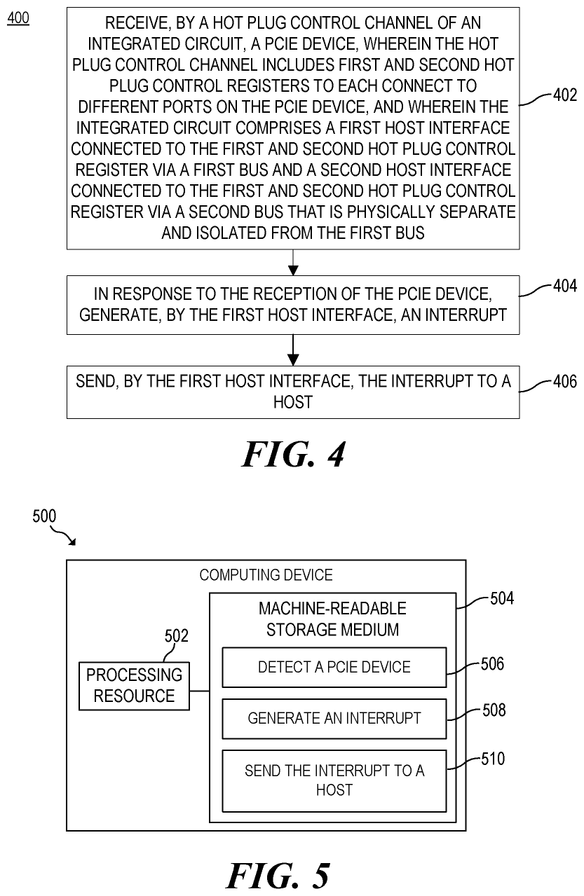

FIG. 4 is a flow chart of a method to, by an integrated circuit, receive a PCIe device, generate an interrupt, and send the interrupt to a host. Although execution of method 400 is described below with reference to the system 300 of FIG. 3, other suitable systems or modules may be utilized, including, but not limited to, system 100, system 200, or computing device 500. Additionally, implementation of method 400 is not limited to such examples.

At block 402, a hot plug control channel of a plurality of hot plug control channels 304 may receive a device 306. The device 306 may be a PCIe device. In an example, the PCIe device may be an NVMe storage device. In another example, the hot plug control channel of the plurality of hot plug control channels 304 may receive a device 306 via a user physically adding a device 306 to the system 300. In other words, a user may add or plug into a slot on the system 300 a device 306. Further, the user may add or plug into a slot on the system 300 the device 306 while the system 300 is operating, running, and/or powered on. In such examples, a slot, connector, or interface may allow reception of devices 306. Further, the slot, connector, or interface may connect to the hot plug control channels 304. Further, certain pins on the slot, connector, or interface may connect to the hot plug control channel 304.

As noted in block 402, the hot plug control channel 304 may be included in an integrated circuit 301. As noted, the integrated circuit 301 may include a plurality of hot plug control channels 304. The integrated circuit 301 may include a plurality of interfaces 310 (e.g., host interface connections). Each interface 310 (e.g., host interface connection) may connect to the hot plug control channels 304 via one of a pair of buses 308. In an example, the integrated circuit 301 may include more than two interfaces 310 (e.g., host interface connections) and more than one pair of buses 308.

At block 404, in response to the reception of the device 306 (e.g., a PCIe device or NVMe storage device), the interface 310 (e.g., host interface connection) may generate an interrupt. The interrupt may indicate to a host 302 that the device 306 may be serviced or initialized. The interface 310 (e.g., host interface connection) may include the appropriate information in the interrupt to indicate to the hosts 302 that the device 306 has been added to the system 300 and that the device 306 may be serviced or initialized. In another example, the interface 310 (e.g., host interface connection) may not generate the interrupt, but another component, module, or hardware of the integrated circuit 301 may instead generate the interrupt. In such an example, a user or application may designate a component to generate the interrupt.

At block 406, the interrupt may be sent to the host 302. In an example, the interface 310 (e.g., host interface connection) may send the interrupt to the host 302. In another example, if another component, module, or hardware of the integrated circuit 301 generated the interrupt, then that other component, module, or hardware of the integrated circuit 301 may send the interrupt, through the interface 310 (e.g., host interface connection), to the host 302. In an example, in response to the reception of the interrupt by the host 302, the host 302 may perform some servicing, initialization, or other action on the device 306. The host 302 may perform the servicing, initialization, or other action through the integrated circuit 301 or through another connection to the device 306 (that other connection is not shown).

FIG. 5 is a block diagram of a computing device to detect a PCIe device, generate an interrupt, and send the interrupt to a host. The computing device 500 may include a processing resource 502 and a machine-readable storage medium 504. The processing resource 502 may execute instructions included in the machine-readable storage medium 504. The machine-readable storage medium 504 may include instructions 506 to detect a PCIe device. In response to the insertion of the PCIe device a hot plug control channel interface, the processing resource 502 may execute the instructions 506 to recognize or detect the PCIe device. In another example, an integrated circuit or hot plug controller may store and execute instructions 506. In a further example, the integrated circuit or hot plug controller may include the hot plug control channel interface. In a further example, the integrated circuit or hot plug controller may include a plurality of hot plug control channel interfaces. In another example, instructions 506 may be executed when a PCIe device is inserted into a slot, channel, connector or some other appropriate interface connected to the hot plug control channel interface.

In another example (and as described above), the integrated circuit or hot plug controller may include a plurality of hot plug control channel interfaces. Each of the hot plug control channel interfaces of the plurality of the hot plug control channel interfaces may connect to one or more buses (for example, redundant buses) internal to the integrated circuit or hot plug controller. In an example, each bus (in the case that the integrated circuit or hot plug controller may contain more than one internal bus) may connect to a plurality of host interfaces internal to the integrated circuit. In another example, each host interface may connect to one of a plurality of internal buses. In a further example, a host may connect to the integrated circuit or hot plug controller via the host interface. In such examples, a host may connect to the integrated circuit or hot plug controller via a plurality of host interfaces (for reliability and availability purpose), each of the host interfaces connecting to the hot plug control channels via one of a plurality of internal buses.

The machine-readable storage medium 504 may include instructions 508 to generate an interrupt. In an example, the processing resource may execute instructions 508 in response to the detection of the PCIe device. In an example, the host interface described above may generate the interrupt. In another example, the hot plug control channel interface may generate the interrupt. In another example, a different component, device, or module of the integrated circuit or hot plug controller may generate the interrupt. In other words, the component, device, or module may include the instructions 508 to generate an interrupt. In response to the detection of a PCIe device, the processing resource 502 may execute the instructions 508 wherever the instructions 508 may be stored.

The machine-readable storage medium 504 may include instructions 510 to send the interrupt to the host. In an example, in response to the generation of the interrupt, the processing resource 502 may execute instructions 510 to send the interrupt to the host. In an example, the interrupt may be sent to the host through the host interface. In another example, the interrupt may be sent to a specific host. In another example, the interrupt may be sent to all hosts in the computing device 500.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims.

1. A system comprising:
a first host and a second host; and
an integrated circuit comprising:
a first bus and a second bus physically separate and isolated from the first bus;
a first host interface to connect the first host to the first bus and a second host interface to connect the second host to the second bus; and
a hot plug control channel including first and second hot plug control registers, wherein each of the hot plug control registers is connectable to redundant ports of a hot pluggable device;
wherein the hot plug control channel is to connect the first bus to the first and second hot plug control register to thereby connect the first host to the first and second hot plug control register, and is to connect the second bus to the first and second hot plug control register to thereby connect the second host to the first and second hot plug control register.

2. The system of claim 1, wherein the first and second hot plug control register receive a different output from and provides a different input to the hot pluggable device.

3. The system of claim 1, wherein the hot pluggable device is a peripheral component interconnect express (PCIe) devices.

4. The system of claim 1, wherein the hot pluggable device is a non-volatile memory express (NVMe) device.

5. The system of claim 1, wherein the first host interface and the second host interface connects to the first host and the second host, respectively, through a serial bus.

6. The system of claim 1, wherein the integrated circuit is a field programmable gate array (FPGA).

7. The system of claim 1, wherein the integrated circuit scales to include varying amounts of hot plug control channels and host interfaces.

8. A method comprising:
receiving, by a hot plug control channel of an integrated circuit, a PCIe device, wherein the hot plug control channel includes first and second hot plug control registers to each connect to different and redundant ports on the PCIe device, and wherein the integrated circuit comprises a first host interface connected to the first and second hot plug control register via a first bus and a second host interface connected to the first and second hot plug control register via a second bus that is physically separate and isolated from the first bus;
in response to the reception of the PCIe device, generating, by the first host interface, an interrupt; and
sending, by the first host interface, the interrupt to a host.

9. (canceled)

10. The method of claim 8, wherein the each host interface connections connects to one host.

11. The method of claim 8, wherein the host interface connections connects to the hosts through an I²C bus.

12. A non-transitory machine-readable storage medium encoded with instructions executable by a processing resource, the non-transitory machine-readable storage medium comprising, instructions to:
in response to the insertion of a PCIe device into a first hot plug control channel, detect the PCIe device, wherein the hot plug control channel includes first and second hot plug control registers to connect to redundant ports of the PCIe device, respectively;
in response the detection of the PCIe device, generate an interrupt in a first host interface connected to the first and second hot plug control register via a first bus physically separate and isolated from a second bus that connects a second host interface to the first and second hot plug control register; and
in response to the generation of the interrupt, send the interrupt to a host through the first host interface, wherein the host interface connects to the host via an inter-integrated circuit (PIC) bus.

13. The non-transitory machine-readable storage medium of claim 12, wherein the non-transitory machine readable storage medium and processing resource are included in an integrated circuit.

14. The non-transitory machine-readable storage medium of claim 13, wherein the integrated circuit includes a plurality of host interfaces, a plurality of separate and isolated buses, and a plurality of hot plug control channels.

15. The non-transitory machine-readable storage medium of claim 12, wherein each hot plug control register includes a private 256 byte address space.

16. The non-transitory machine-readable storage medium of claim 12, wherein each hot plug control register is accessible by separate I²C device IDs.

17. The non-transitory machine-readable storage medium of claim 12, wherein the PCIe device is an NVMe drive.
